(19) United States
(12) Patent Application Publication
(10) Pub. No.: US 2016/0245565 A1
(43) Pub. Date: Aug. 25, 2016

(54) Modular Heat Recovery System

(71) Applicant: CSM Energy Solutions, LLC, Fenton, MI (US)

(72) Inventor: Craig S. Mortz, Fenton, MI (US)

(21) Appl. No.: 14/843,104

(22) Filed: Sep. 2, 2015

Related U.S. Application Data
(60) Provisional application No. 62/044,525, filed on Sep. 2, 2014.

(51) Int. Cl. F25B 49/00; F25B 30/06; B23P 19/00

(52) U.S. Cl. CPC F25B 49/00; B23P 19/00; F25B 30/06

(57) ABSTRACT

An expandable modular system including standardized dual heat pump modules that are connectable to other standardized heat pump modules. The modules include pumps for a source fluid and for heat transfer fluid that is circulated to a point of use. The heat pump modules are controlled by a dedicated programmable logic controller. The system may be adapted to transfer heat from a source stream that would otherwise be wasted or not utilized for thermal energy rectification. The modules are of limited size to fit through pedestrian doors and are pre-assembled prior to installation.

### CROSS-REFERENCE TO RELATED APPLICATIONS

This application claims the benefit of U.S. provisional application Ser. No. 62/044,525 filed Sep. 2, 2014, the disclosure of which is hereby incorporated in its entirety by reference herein.

### TECHNICAL FIELD

This disclosure relates to a modular heat recovery system that is scalable by adding additional heat pump modules that are controlled by a power control module and that includes a dual pump module that independently pumps a source stream fluid and a heat transfer fluid through the heat pump modules to a building HVAC system.

### BACKGROUND

Heat recovery systems are known and are built as custom installations designed to meet the heating and cooling requirements of a specific building. Custom installations are assembled and connected by piping and wiring that is laid out and installed on-site. The cost of building such systems is a serious disadvantage that adversely impacts cost-benefit analyses, cost savings, and payback analyses. Such systems are also expensive to upgrade to provide additional capacity and/or capacity reduction as the heating and cooling requirements for a building load increase and/or decrease.

Another problem with custom installations is that they are not readily scalable and are not normally designed to be serviced easily. It is also difficult to service one or more heat pumps while operating the heat recovery system.

The following patents and published patent applications were considered in conjunction with preparing this disclosure: U.S. Pat. Nos. 3,434,532; 5,339,891; 8,245,491; 8,627,674; and US 2011/0240269.

The following disclosure is directed to solving the above problems and other problems as summarized below.

### SUMMARY

The heat recovery system that is the subject of this disclosure is an expandable modular system that uses standardized dual heat pump modules that are connectable to other standardized modules. The heat pump modules are connected mechanically and electrically and are controlled by a standardized programmable logic controller. The system may be adapted to transfer heat from a source stream that would otherwise be wasted or not utilized for thermal energy rectification. For example, a wastewater treatment effluent flow could be used as the source stream with the heat recovered being used for heating, cooling and/or dehumidification of a building.

The system is packaged to be easily installed as a plurality of modules in buildings through conventional sized pedestrian doorways. Pedestrian doorways are distinguished from other doorways that may be garage or loading dock doorways by specifying that pedestrian doorways are less than one meter in width and less than 3 meters in height. The ideal location for installing a waste heat recovery system may be only accessible through one or more pedestrian doors in many buildings. Large systems cannot fit through pedestrian doors and must be provided as smaller component parts that are assembled as a custom system that is built on site. Alternatively, the walls of the building may be removed and replaced. Either of these approaches adds unnecessary cost and discourages the use of waste heat recovery systems.

The system includes three systems that are combined in a standardized module—a heat pump system, a pump system for a source fluid and a heat transfer fluid, and a power/control system. The piping and wiring between the systems is standardized to facilitate easy installation. The standardized modules may be combined with other standardized modules to provide a scalable waste heat recovery system for buildings that have a wide range of heat or cooling requirements.

The heat pump modules are packaged as stand-alone modules that may be independently installed and/or installed with a plurality of additional modules. Standardized input and output connectors for mechanical and electrical controls allow for expansion of the system by adding additional heat pump modules, as required. The connectors are located to allow for additional modules to be attached to a pre-existing system as well. As an alternative, the heat pump modules may be provided with air-to-air and/or water-to-air heat exchange systems that could be capable of capturing heat from heated air that may be used to augment existing HVAC systems to satisfy heating and cooling loads.

The dual pump module serves the dual functions of pumping the source stream and the heat transfer fluid. The source stream may be any source of flowing fluid (e.g. water) from which heat is extracted. For example, the source stream may be waste water effluent that has a substantial amount of thermal energy that is normally wasted. The heat transfer fluid (e.g. water, ethylene glycol or propylene glycol) is pumped from the heat pump module to a space conditioning point of use in a building, such as an air handling unit or hydronic conditioning coil for space conditioning purposes. The dual pump module may accommodate varied pump and fluid transfer requirements. The dual pump module also houses an expansion tank for maintaining consistent heat transfer fluid pressure within the operating system.

The power control module features an integrated electrical power supply and electronic control system. The power control module is adapted to be directly connected to the heat pump modules and the dual pump module. The control system interconnects and coordinates the heat pump modules and the dual pump module using standardized interfaces. The power control module may be connected to the host facility power supply, as well as heating and air conditioning system controls and/or facility-operated building management systems, such as a Supervisory Control and Data Acquisition (SCADA) system.

According to one aspect of this disclosure, a method is provided for recovering waste heat in a building having a location for recovery of waste heat that is only easily accessible through at least one pedestrian door. The method comprises the steps of:
assembling at least two dual heat pump modules, a source water pump, a heat transfer fluid pump, and a controller to a frame;
connecting piping between the heat pump modules, the source water pump, and the heat transfer fluid pump to form an assembled modular unit;
transporting the assembled modular unit through the at least one of the pedestrian door into the building;
connecting the source water pump to a stream of a source fluid;
connecting the heat transfer fluid pump to a heat transfer fluid circuit that circulates a heat transfer fluid; and
connecting the controller to a power source.

According to other aspects of this disclosure, the method may further comprise balancing the flow of the source fluid with a set of inlet balancing valves and a set of outlet balancing valves. The balancing step may be performed automatically with automatic flow regulator/valves.

According to another aspect of this disclosure, the method may further comprise controlling the operation of the heat pump modules, the source water pump, the heat transfer fluid pump based upon a temperature of the source fluid and a temperature of the heat transfer fluid.

The method may also further comprise controlling the operation of the heat pump modules, the source water pump, and the heat transfer fluid pump based upon the flow rate in the heat transfer fluid circuit.

To provide scalability, two or more assembled modular units may be provided in combination with the first assembled modular unit by repeating the steps for providing the first assembled modular unit.

According to another aspect of this disclosure, a modular heat recovery system is disclosed that comprises a frame and at least two dual heat pump modules assembled to the frame. A source water pump is connected by piping to the dual heat pump modules. A heat transfer fluid pump is connected by piping to the dual heat pump modules. A controller is electrically connected to the dual heat pump modules, the source water pump and the heat transfer fluid pump to form a modular unit that is adapted to be transported through a pedestrian door.

According to other aspects of this disclosure, the modular heat recovery system is adapted to be transported through a pedestrian door having a width of less than one meter and a height of less than three meters.

The modular heat recovery system may further comprise a set of inlet balancing valves connected to the source water pump and the heat pump modules and a set of outlet balancing valves connected to the source water pump and the heat pump modules. The inlet balancing valves and the outlet balancing valves may be automatic flow regulator/valves.

The controller controls the operation of the heat pump modules, the source water pump, the heat transfer fluid pump based upon a temperature of the source fluid and a temperature of the heat transfer fluid. As an alternative or in combination, the controller may control the operation of the heat pump modules, the source water pump, the heat transfer fluid pump based upon a flow rate in the heat transfer fluid circuit.

The modular heat recovery system may be scaled by providing two or more frames with one or two heat pump modules, a source water pump, a heat transfer fluid pump and a controller for controlling the heat pump modules, the source water pump and the heat transfer fluid pump to form two or more assembled modular units that are each separately adapted to be transported through the pedestrian door.

The above aspects of this disclosure and other aspects are described below with reference to the attached drawings.

### BRIEF DESCRIPTION OF THE DRAWINGS

FIG. 1 is a perspective view of a modular heat recovery system made according to one embodiment of this disclosure.

FIG. 2 is a simplified schematic view of the fluid and electrical control circuit of the modular heat recovery system illustrated in FIG. 1.

FIG. 3 is a detailed schematic of one embodiment of the heat recovery system of this disclosure.

FIGS. 4A and 4B are perspective views of the front and rear sides, respectively, of an alternative modular dual heat recovery system made according to a second embodiment of this disclosure.

FIG. 5 is an exploded perspective view of the modular dual heat recovery system of FIG. 4.

FIG. 6 is a perspective view of three modular dual heat recovery systems connected together as an integrated scalable system.

FIG. 7 is a detailed schematic of one embodiment of the heat recovery system of FIG. 4.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

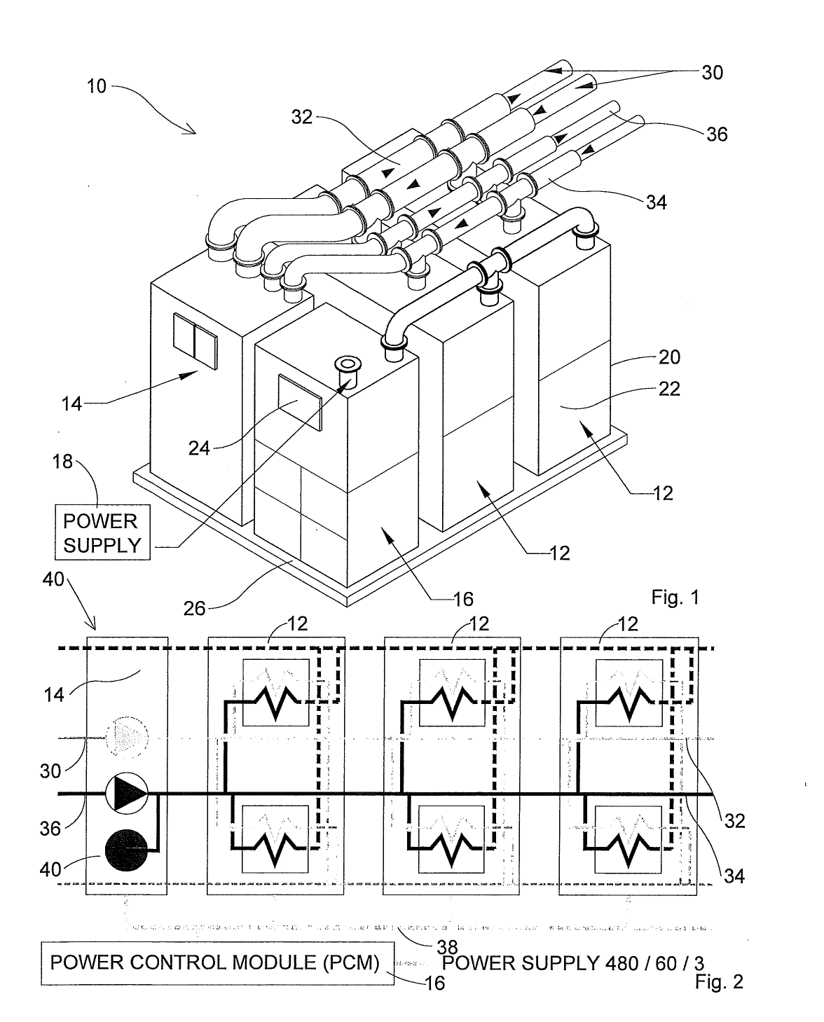

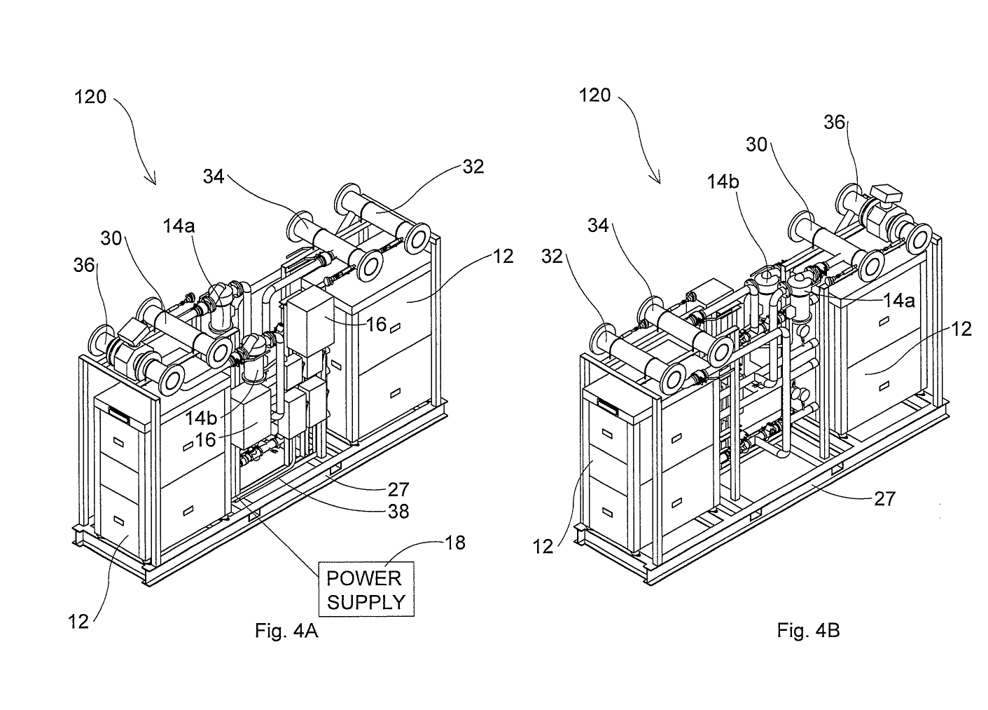

Referring to FIGS. 1, 4A and 4B, a modular heat recovery system is generally indicated by reference numeral 10 (in FIG. 1) or 120 (in FIGS. 4A and 4B) that are capable of recovering heat from a source of flowing water, air or other fluid. For example, effluent from a waste water treatment facility may be the source of water that heat may be recovered from to heat or cool a building. Other sources of flowing fluids may be used with the modular heat recovery system 10 such as irrigation systems, geo-thermal systems, and the like. A principal focus of the system is that it is comprised of small preassembled modules that can be installed as modular units in existing buildings that have conventional sized access doors. The system is scalable to fulfill the HVAC requirements of a wide range of buildings by adding additional heat pump modules and selecting fluid pumps accordingly.

The heat pump modules 12 are high efficiency heat pumps that include a compressor (a dual scroll compressor), heat exchanger, condenser and expansion valve (not shown in FIG. 1). A dual pump module 14 (shown in FIG. 1) is provided that has a source loop pump that pumps the source fluid through the heat pump modules that include a pair of parallel heat pumps. In the embodiment of FIGS. 4A and 4B, a source water pump 14a is illustrated that pumps the source fluid through the heat pump modules and a heat transfer fluid pump 14b is illustrated that pumps the Heat Transfer Fluid (“HTF”) through the heat pump modules. The heat pump modules 12 are connected in parallel for independent operation. The dual pump module 14, as shown in FIG. 1, includes a load loop pump that pumps the HTF through the heat pump modules in series to the heating and/or dehumidifier/air conditioning points of use. The heat transfer fluid pump 14b pumps HTF through the heat pump modules in series to the heating and/or dehumidifier/air conditioning systems.

A Programmable Logic Control (PLC) module 16 is provided that is connected to a power supply 18 that may be a 208-230/460 volt, 60 cycle, 3 phase power source from the electrical power grid. The system may also be adapted to be powered by other power supplies. The PLC module 16 controls the operation of the heat pump modules 12 and the dual pump module 14 (or source water pump 14a and heat transfer fluid pump 14b). The PLC module 16 also provides control logic to the heat pump modules 12 and the dual pump module 14 (or source water pump 14a and heat transfer fluid pump 14b).

Referring to FIG. 1, standardized cabinets having over all dimensions less than or equal to a standard doorway, e.g. 34½ W×78½ H×96 L, are provided to house the heat pump modules 12, dual pump module 14 and PLC module 16. The cabinets may have removable service panels 22 to facilitate inspection and repair of the system. A Human Machine Interface (HMI) 22 is provided on the PLC module 16 to facilitate monitoring and adjusting the modular heat recovery system 10. The modules may be assembled on a platform 26 or may be attached to a frame 27, as shown in FIGS. 4A and 4B.

The heat pump modules 12 and dual pump module 14 (or source water pump 14a) are connected by source supply piping 30 and source return piping 32 in series with standardized couplings to facilitate installation and expansion of the system 10. Likewise, the heat pump modules 12 and dual pump module 14 (or heat transfer fluid pump 14b) are connected by heat transfer fluid piping 30 in series with standardized couplings to facilitate installation and expansion of the system 10.

Power and control wiring conduit 38 is also shown in FIG. 1 that is connected to the heat pump modules 12 and the PLC system 16. The PLC system 16 and the dual pump modules 14 are also connected by wiring that are also in a conduit that is are not visible in FIG. 1. The power and control conduit 38 connects the heat pump modules 12 in series and with the PLC system 16 with standardized couplings to facilitate installation and expansion of the system 10.

Referring to FIG. 2, two (2) dual heat pump modules 12, the dual pump module 14 and PLC system 16 are illustrated in a schematic diagram 40. The PLC system 16 provides power from the power supply 18 to the system 10 that is distributed to the heat pump modules 12 and the dual pump module 14 through the power and control conduit 38.

The source supply piping 30 feeds the dual pump module 14 with a fluid that is pumped to the heat pump modules 12. In a heating system, heat is transferred from the source fluid in the heat pump modules to the HTF in the load loop return piping 36 that is also pumped in parallel by the dual pump module. The fluid is directed to the source return piping 32 back to the source or to a drain after passing through the heat pump modules 12.

An expansion tank 40 is provided to maintaining consistent heat transfer fluid pressure within the operating system. The heated HTF is then directed through the load loop supply piping 34 to heat the building.

The heat pump modules 12 each include two compressors, two heat exchangers, two condensers and two expansion valves that are graphically represented by block 42 in FIG. 2.

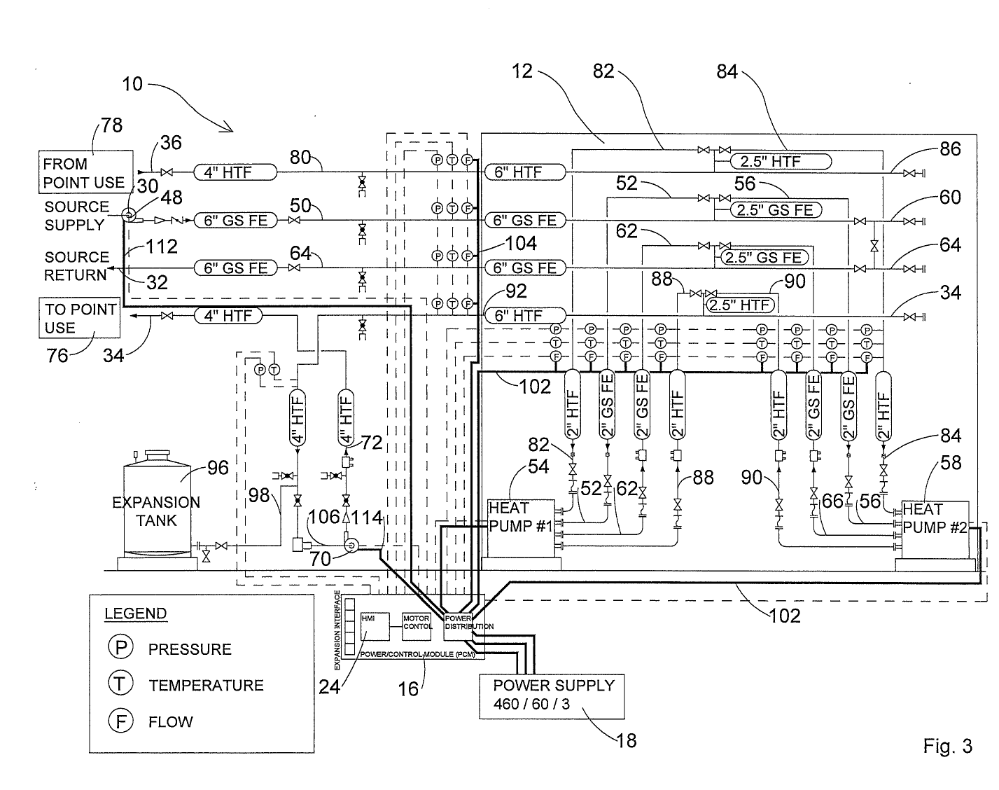

Referring to FIG. 3, a schematic of the piping, power distribution and data feedback for the modular heat recovery system 10 is provided. The heat pump module 12 corresponding to the block 42 in FIG. 2 is shown with the programmable logic control system 16 that is powered by the power supply 18. The Human Machine Interface (HMI) 24 is used to control the PLC system 16 and modular heat recovery system 10.

Source influent piping 30 supplies water or other source fluid to a source pump 48. The source pump 48 pumps the fluid through a check valve into source distribution piping 50 and into the heat pump module 12. The fluid in the source distribution piping 50 is directed through a first heat pump branch 52 through an isolation valve to a first heat pump 54. Part of the source fluid is directed to the second heat pump branch 56 that supplies the source fluid to the second heat pump 58.

The first heat pump 54 and second heat pump 58 are connected in parallel to each other and are both included as part of the heat pump module 12. In this case, the first heat pump module corresponds to block 42 in FIG. 2. If, as anticipated, several heat pump modules 12 are included in the modular heat recovery system 10, as shown in FIG. 2, the other heat pump modules 12 are connected through additional isolation valves by a serially connected heat pump piping 60. The additional heat pump modules 12 are added as heating or cooling requirements of a building increase.

A first source return piping branch 62 returns the source fluid from the first heat pump 54 through an isolation valve and a balancing valve to source return piping 64. The balancing valve provides flow control at each heat pump. Similarly, a second source control piping branch 66 provides for the return of source fluid from the second heat pump 58 through an isolation valve and a balancing valve to the source return piping 64.

HTF pump 70 pumps the heat transfer fluid through HTF distribution pump piping 72 including isolation valves and a balancing valve to the point of use 76, or load that transfers heat to the building or cools and dehumidifies the building depending upon whether the system is a heating or cooling system. The HTF returns from the point of use at 78 after having transferred heat to or from the building.

The HTF is directed through an isolation valve into heat transfer fluid return distribution piping 80. The HTF flowing through the heat transfer fluid return distribution piping 80 is directed through an isolation valve to a first heat pump branch 82 and through an isolation valve to a second heat pump branch 84 that provide heat transfer fluid to the first heat pump 54 and second heat pump 58, respectively. Serially connected heat pump piping 86 directs the HTF through an isolation valve to subsequent heat pump modules 12 that are provided as part of the modular heat recovery system 10. A first HTF supply piping branch 88 and a second HTF supply piping branch 90 direct the HTF through separate isolation valves and balancing valves into HTF distribution piping 92.

The HTF distribution piping 92 supplies the heat transfer fluid to an expansion tank branch 98. The expansion tank branch 98 provides heat transfer fluid to an expansion tank 40 that compensates for variation heat transfer fluid pressure and maintains consistent heat transfer fluid pressure. The expansion tank branch 98 includes an expansion tank branch 98 that provides the heat transfer fluid through an isolation valve to the expansion tank 40. The expansion tank branch 98 also includes a HTF pump branch 100 that provides the heat transfer fluid to the heat transfer pump 70.

Heat pump sensor power supply wiring 102 provides power to sensors that are used to monitor the operation of the modular heat recovery system 10. Distribution sensor power supply wiring 104 provides power to sensors in the source and HTF fluid distribution portions of the system. Pressure sensors 106 (P), temperature sensors 108 (T) and flow sensors 110 (F) monitor the pressure, temperature and flow of the source fluid and HTF throughout the heat recovery system 10. The sensors provide pressure, temperature and flow data through wiring 112 (or by wireless communication) to the PLC system 16.

The PLC system 16 provides power through a source pump power supply 114 to the source pump 48. A HTF pump power supply 116 similarly provides power to the HTF pump 70. The power supplied to the source pump 48 and HTF pump 70 is controlled based upon the data received from the pressure sensors 106, temperature sensors 108 and flow sensors 110.

Operation of the instrumentation and PLC system for the modular heat recovery system 10 is described below.

The heat recovery system 10 includes heat pump modules 12 that each includes two heat pumps 54 and 58. The PLC control system 16 determines the sequence for initiating the system operation. The heat pumps are staged based upon the return temperature of the load loop 34. As the load loop 34 temperature decreases (in a heating system or mode), the heat pumps 54 and 58 are started and the HTF in the load loop return 36 is heated.

The PLC system 16 may be configured to sequence operation of the heat pumps 54 and 58. The PLC system 16 can automatically alternate operation of the two heat pumps within the heat pump module 12. The PLC system 16 determines which heat pump is turned on first and which is turned off first and also provides the ability to remove a heat pump from service. In the event the source influent supply is interrupted, or insufficient, the PLC system 16 may be programmed to shut down the heat pumps until adequate influent supply is available.

Enabling the modular heat recovery system 10 is a manual operation controlled by building maintenance personnel through the human machine interface (HMI) 24. For example, in a heating system, the modular heat recovery system 10 may be enabled in the fall and disabled in the spring based upon outside air temperature and building HVAC requirements. If the heat recovery system 10 is configured to provide both heating and cooling, the system may be automatically controlled to provide the heating and cooling source for the HVAC system.

When the heat recovery system 10 is enabled, the source loop pump 48 and load loop pump 70 are started and the selected heat pump module 12 is started to begin heating or cooling the HTF. Additional heat pumps may be staged based upon increasing or decreasing load loop return temperatures. As the load loop return 36 temperatures vary, additional heat pump modules 12 may be started depending upon the increasing or decreasing load loop return 36 temperature. The temperature value set points for staging the heat pump modules 12 to turn on or turn off are user definable and may be entered into the PLC system 16 by the HMI 24.

The heat recovery system 10 reduces energy costs while optimizing performance of the HVAC system of a building. The heat pump modules 12 remove heat or add heat to the source influent to efficiently transfer heat. Heat transfer fluid is used to transfer heat to the point of use, or load, heat exchangers. Waste heat is thus repurposed for use in heating a building and reduces or eliminates the need to use gas or electricity to heat or cool a building.

The source supply fluid may include sediment and there is no need to filter or otherwise act upon the source fluid as it flows through the system. The modular heat recovery system 10 may be used with a waste water treatment facility or any other facility where a reliable source of flowing water or other fluid having the appropriate temperature and flow characteristics is available.

In general, the system is expected to improve the reliability of HVAC systems because there is no need for make-up air unit burners. In addition, the heat recovery system allows bypassing individual heat pump modules during system maintenance or repair operations so that system operation does not need to be interrupted.

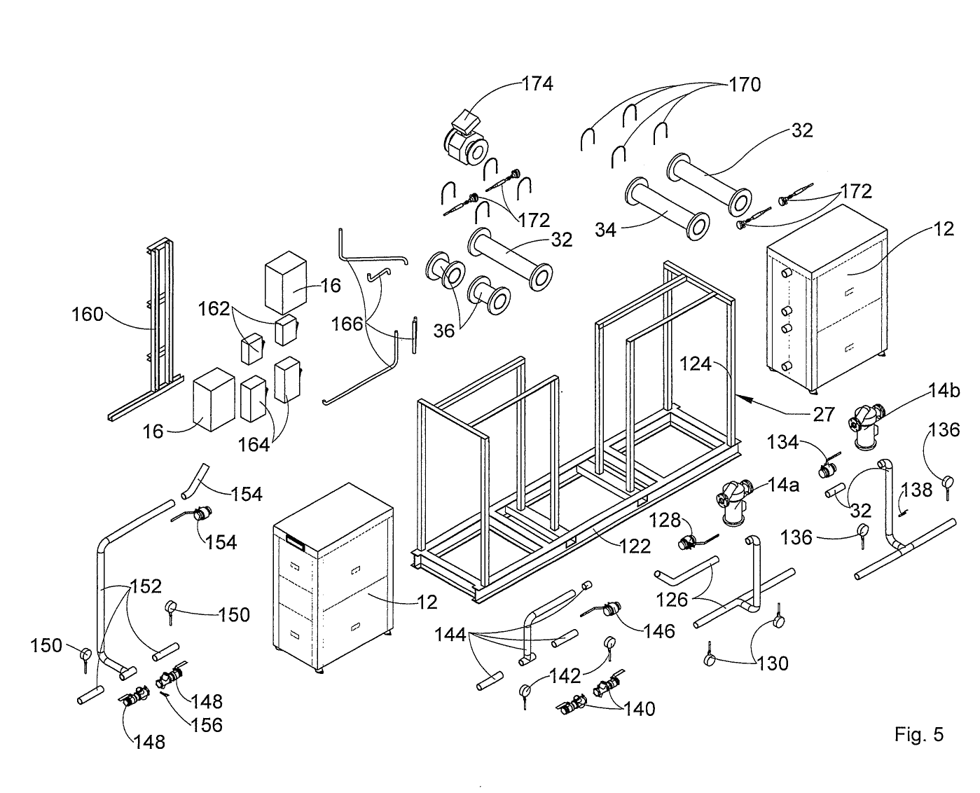

Referring to FIG. 5, the component parts of the alternative embodiment of the modular heat recovery system 120 are illustrated. The frame 27 includes a base 122 to which supports 124 are attached. The components of the modular heat recovery system 120 are secured to the base 122 and supports 124. The dimensions of the base 122, supports 124 and components attached thereto are minimized to permit the modular heat recovery system 120 to be transported through a conventional door. As used herein, the term conventional door refers to a pedestrian door having a width of less than one meter and a height of less than three meters.

The heat pump modules 12 are attached to the opposite ends of the base 122 and are also secured to the supports 124. Source water piping 126 is connected to the source fluid, such as a waste water stream, and provides the source water or fluid to the two heat pump modules 12 that are assembled to the base 122. Source water pump 14A provides the source water under pressure to the source water piping 126. A ball valve 128 is provided to allow the source water to be selectively turned on and off for service operations. A pair of pressure gauges 130 are provided to monitor the pressure of the source water provided to the heat pump modules 12.

Heat transfer fluid piping 132 is connected to the heat transfer fluid pump 14B. The heat transfer fluid piping 132 provides the heat transfer fluid to the heat pump modules 12. A ball valve 134 is provided in the heat transfer fluid piping 132 to control the flow of heat transfer fluid and permit selective interruption of the flow of heat transfer fluid. Pressure gauges 136 monitor the pressure within two branches of the heat transfer fluid piping 132 that are provided to the heat pump modules 12. A drain valve 138 is provided to permit the heat transfer fluid to be drained during service operations.

Balancing valves 140 are provided for balancing the heat transfer fluid within the system. A pair of pressure gauges 142 are used to monitor the pressure within the heat transfer fluid as it flows through the balancing valve piping 144. A ball valve 146 allows the flow of heat transfer fluid through the balancing valve piping 144 to be turned on and off.

Balancing valves 148 are also provided for the source fluid that facilitate balancing the flow of fluid through the modular heat recovery system 120. The balancing valves 148 are monitored by pressure gauges 150 that are assembled to the balancing valve piping 152. A ball valve 154 is provided to permit the flow of source fluid through the balancing valve piping 152 to be turned on and off. A drain 156 is provided to permit the source fluid to be drained from the balancing valve piping 152 during service operations.

A rack 160 is assembled to the base 122 and supports 124 of the frame 27. The PLC system 16 for each heat pump module 12 is assembled to the rack 160. The rack is adapted to support a pair of 30 amp safety switches 152 and 60 amp safety switches 164. The safety switches 162 and 164 and PLC system 16 are connected by wiring in conduits 166.

U-bolt 170 type brackets are provided to secure the source influent piping 30, source effluent piping 32, load loop supply piping 34 and load loop return piping 36 to the supports 124. The length of the piping 30, 32, 34 and 36 is limited to approximately the width of the modular heat recovery system 10 so that the piping and all the other components of the modular heat recovery system 10 can be preassembled at a remote location and moved into a building to be serviced by the modular heat recovery system. The size of the module is limited to be able to fit within pedestrian doors, as previously indicated, so that the only assembly necessary within the building is the connection of multiple modules and connections to the source fluid and heat transfer/load circuits.

Temperature sensors 172 are provided in the source effluent piping 32 and the load loop supply piping 34. A flow meter 174 is provided in the heat transfer fluid return 36. The flow meter 174 monitors the rate of flow of the heat transfer fluid through the load loop return 36.

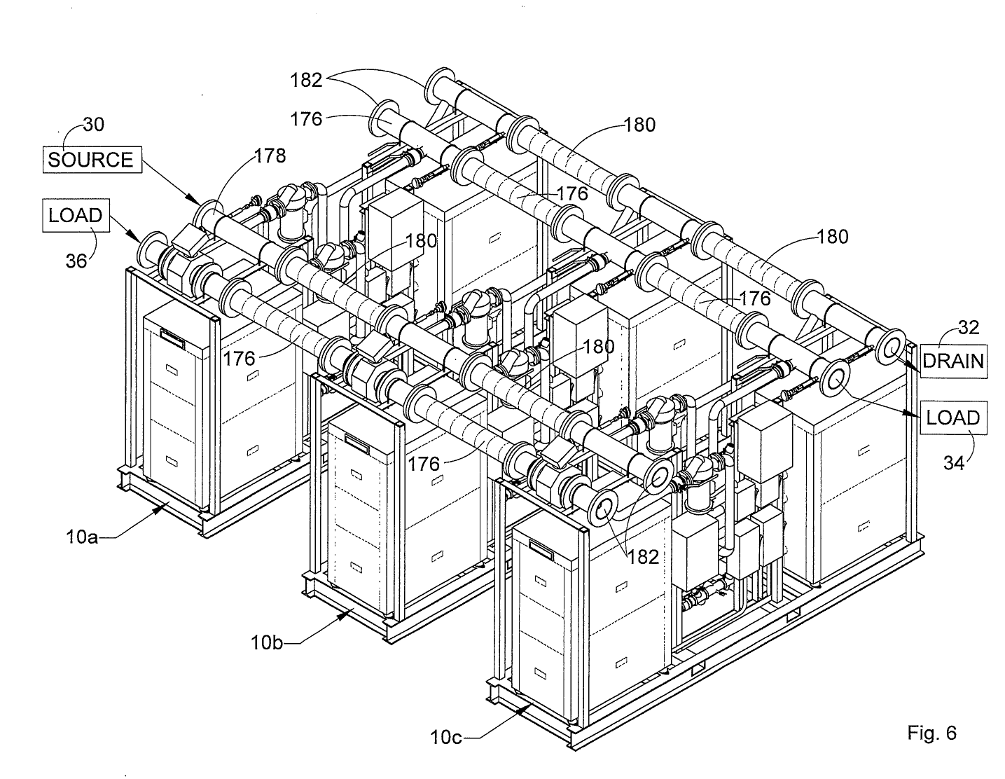

Referring to FIG. 6, HTF piping connector segments 176 are connected between adjacent modular heat recovery systems indicated by 10a, 10b and 10c in FIG. 6. The HTF connector piping segments may be of standardized length to facilitate assembly of multiple modules and also assure adequate spacing between modules for servicing. Similarly, source fluid piping connector segments 180 are provided to connect adjacent modular heat recovery systems 10a, 10b, and 10c. Caps 182 are provided on one end of each of the load and source piping connections.

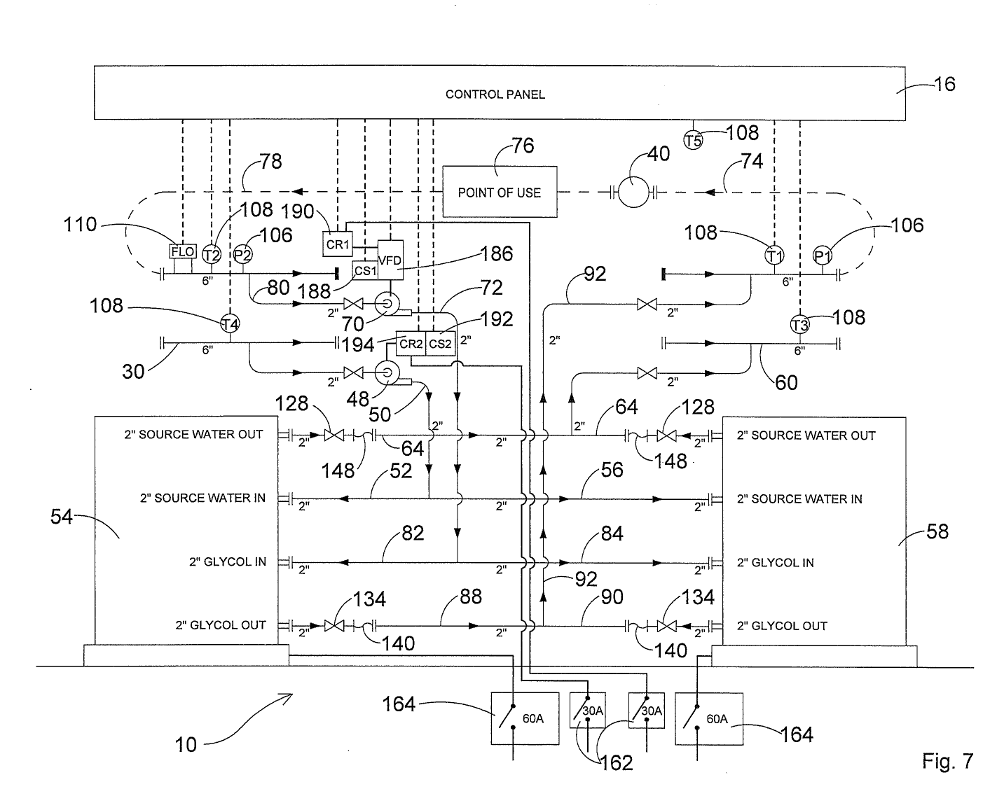

Referring to FIG. 7, a schematic of the modular heat recovery system 120 is provided. Source influent piping 30 supplies water or another source fluid to a source pump 48. The source pump 48 pumps fluid through source distribution piping 50 and into the two heat pump modules 12 through a first heat pump branch 52 and a second heat pump branch 56 to the second heat pump 58.

The first heat pump 54 and second heat pump 58 are connected in parallel to each other and are both included as part of one of the heat pump modules 12. If more than one modular heat recovery systems is required, additional heat pump modules 12 are connected through isolation valves by serially connected heat pump piping. Additional heat pump modules 12 are added as heating or cooling requirements of a building change.

A first source return piping branch 64 returns the source fluid from the heat pump modules 54 and 58 through ball valves 128 and automatic balancing valves 148. The balancing valves 148 provide flow control for each heat pump. The source water from the source return piping branch 64 is provided to the heat pump piping 60 for return to the source fluid stream.

Heat transfer fluid pump 70 pumps the heat transfer fluid through the HTF distribution piping 72 and into the first heat pump branch 82 and through an isolation valve to a second heat pump branch 84 to provide heat transfer fluid to the first heat pump 54 and second heat pump 58, respectively. A first heat transfer supply piping branch 88 and second HTF supply piping branch 90 supply HTF to distribution piping 92 and heat pumps 54 and 58 prior to being supplied to the distribution branches 88 and 90. The HTF is supplied through the HTF load supply line 74 to a pressure tank 40 that may also be referred to as an expansion tank. The HTF flowing from the pressure tank 40 is provided to HTF distribution pumping to the point of use 76. The point of use 76 refers to the heating or air conditioning units in a building that are used to heat and cool the building. After supplying the HTF to the building, HTF is returned through return piping from the point of use at 78. Flow meter 110 measures the flow of the returning HTF. The HTF is then returned through HTF return distribution piping 80 to the HTF pump 70.

The HTF pump 70 may be controlled by a variable frequency drive 186. The variable frequency drive 186 controls the displacement of the HTF pumps 70. A HTF pump current sensor 188 monitors the variable frequency drive 186 and a HTF pump control relay 190 is provided to control the operation of the variable frequency drive 186.

The source fluid pump 48 is monitored by a source fluid pump current sensor 192 that cooperates and provides source fluid pump current data that is used to control a source fluid pump control relay 194. The source fluid pump control relay 194 controls the operation of the source fluid pump 48.

The temperature of the source fluid is measured by temperature sensor 108-T1. The returning HTF is also sensed by temperature sensor 108-T2 and the pressure of the returning HTF is sensed by a pressure sensor 106-P2. Temperature sensor 108-T3 measures the temperature of the source fluid effluent and provides this information to the control panel 16. Temperature sensor 108-T4 measures the source water supply to the source water return temperature and provides this temperature information to the control panel 16.

Thirty amp safety switches 162 and 60 amp safety switches 164 provide a safety disconnect for the pumps and the heat exchange modules 54-58.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A method of recovering waste heat in a building having at least one pedestrian door, the method comprising:
assembling dual heat pump modules, a source water pump, a heat transfer fluid pump, and a controller to a frame;
connecting piping between the dual heat pump modules, the source water pump, and the heat transfer fluid pump to form an assembled modular unit;
transporting the assembled modular unit through the at least one pedestrian door into the building;
connecting the source water pump to a stream of a source fluid;
connecting the heat transfer fluid pump to a heat transfer fluid circuit that circulates a heat transfer fluid; and
connecting the controller to a power source.

2. The method of claim 1 further comprising:
balancing the flow of the source fluid with a set of inlet balancing valves and a set of outlet balancing valves.

3. The method of claim 2 wherein the balancing step is performed automatically with automatic flow regulator/valves.

4. The method of claim 1 further comprising:
controlling the operation of the heat pump modules, the source water pump, the heat transfer fluid pump based upon a temperature of the source fluid and a temperature of the heat transfer fluid.

5. The method of claim 4 further comprising:
controlling the operation of the heat pump modules, the source water pump, and the heat transfer fluid pump based upon the flow rate in the heat transfer fluid circuit.

6. The method of claim 1 further comprising:
assembling a second heat pump module, a second source water pump, a second heat transfer fluid pump, and a controller to a frame;
connecting piping between the second heat pump module, the second source water pump, and the second heat transfer fluid pump to form a second assembled modular unit;
transporting the second assembled modular unit through the at least one pedestrian door into the building;
connecting the second source water pump to the stream of the source fluid;
connecting the second heat transfer fluid pump to the heat transfer fluid circuit that circulates the heat transfer fluid; and
connecting the second controller to a power source.

7. The method of claim 1 further comprising:
assembling a second set of dual heat pump modules, a second source water pump, a second heat transfer fluid pump, and a controller to a frame;
connecting piping between the second set of dual heat pump modules, the second source water pump, and the second heat transfer fluid pump to form a second assembled modular unit;
transporting the second assembled modular unit through the at least one pedestrian door into the building;
connecting the second source water pump to the stream of the source fluid;
connecting the second heat transfer fluid pump to the heat transfer fluid circuit that circulates the heat transfer fluid; and
connecting the second controller to a power source.

8. A modular heat recovery system comprising:
a frame;
a set of two heat pump modules assembled to the frame;
a source water pump connected by piping to the heat pump modules;
a heat transfer fluid pump connected by piping to the heat pump modules;
a controller electrically connected to the heat pump modules, the source water pump and the heat transfer fluid pump to form a modular unit that is adapted to be transported through a pedestrian door.

9. The modular heat recovery system of claim 8 wherein the pedestrian door having a width of less than one meter and a height of less than three meters.

10. The modular heat recovery system of claim 8 further comprising:
a set of inlet balancing valves connected to the source water pump and the heat pump modules; and
a set of outlet balancing valves connected to the source water pump and the heat pump modules.

11. The modular heat recovery system of claim 10 wherein the inlet balancing valves and the outlet balancing valves are automatic flow regulator/valves.

12. The modular heat recovery system of claim 8 wherein the controller controls the operation of the heat pump modules, the source water pump, the heat transfer fluid pump based upon a temperature of the source fluid and a temperature of the heat transfer fluid.

13. The modular heat recovery system of claim 12 wherein the controller controls the operation of the heat pump modules, the source water pump, the heat transfer fluid pump based upon a flow rate in the heat transfer fluid circuit.

14. The modular heat recovery system of claim 8 further comprising:
a second frame;
a second heat pump module assembled to the second frame;
a second source water pump connected by piping to the second heat pump module;
a second heat transfer fluid pump connected by piping to the second heat pump module;
a controller electrically connected to the second heat pump module, the second source water pump and the second heat transfer fluid pump to form a second assembled modular unit that is adapted to be transported through the pedestrian door.

15. A modular heat recovery system of claim 8 further comprising:
a second frame;
a second set of two heat pump modules assembled to the second frame;
a second source water pump connected by piping to the second set of heat pump modules;
a second heat transfer fluid pump connected by piping to the second set of the heat pump modules; and
a controller electrically connected to the second set of dual heat pump modules, the second source water pump, and the second heat transfer fluid pump to form a second assembled modular unit that is adapted to be transported through the pedestrian door.
